(19) United States
(12) Patent Application Publication
(10) Pub. No.: US 2011/0147530 A1
(43) Pub. Date: Jun. 23, 2011

(54) AUXILIARY FUEL TANK SYSTEM

(75) Inventors: Taifur Rahman, Saint-Laurent (CA); David F.E. Miles, Kirkland (CA)

(73) Assignee: ELISEN TECHNOLOGIES INC., Dorval, QC (CA)

(21) Appl. No.: 12/993,039

(22) PCT Filed: May 19, 2009
(86) PCT No.: PCT/CA2009/000687

§ 371 Date: Jan. 27, 2011

Related U.S. Application Data
(60) Provisional application No. 61/053,859, filed on May 16, 2008.

(51) Int. Cl. B64D 37/20; B64D 37/02; B64C 1/18

(52) U.S. Cl. 244/135 C; 244/135 R

(57) ABSTRACT

An auxiliary fuel tank system connected to a main tank of an aircraft having a refuel input assembly. The auxiliary fuel tank system comprises an ejector system operatively connected to the refuel input assembly, a forward tank operatively connected to the ejector system, and/or at least one aft tank operatively connected to the ejector system. The forward and/or at least one aft tank transfer fuel to the main tank using gravity.

### CROSS REFERENCE TO RELATED APPLICATIONS

This application claims priority on U.S. Provisional Application No. 61/053,859, filed on May 16, 2008 and which is herein incorporated by reference in its entirety.

### FIELD OF THE INVENTION

The present invention relates generally to aircraft fuel tank systems and, more particularly, to auxiliary fuel tank systems that can be installed in aircraft fuselages.

### BACKGROUND OF THE INVENTION

Aircrafts are generally equipped with main fuel tanks normally located in the wings and center wing box. These main tanks are typically permanently fitted to the aircraft and are of a rigid construction. The capacity of the main fuel tanks is designed to carry a given load over a given range. In practice, however, the need arises to increase the range of the aircraft to serve longer routes. Increasing the range requires, for example, increasing the fuel capacity of the aircraft by adding an auxiliary fuel tank system.

However, the addition of an auxiliary fuel tank system is subject to certification standards that restrict its implementation. Indeed, known auxiliary fuel tank systems use auxiliary pump systems and additional electrical wiring that increase the difficulties of attaining the aforementioned certification standards.

Thus, there exits a need in the industry for an auxiliary fuel tank system that is relatively easier to certify than the known auxiliary fuel tank systems.

### SUMMARY OF THE INVENTION

In accordance with the present invention, there is provided an auxiliary fuel tank system connected to a main tank of an aircraft having a refuel input assembly. The auxiliary fuel tank system comprises an ejector system operatively connected to the refuel input assembly and a forward tank operatively connected to the ejector system and/or at least one aft tank operatively connected to the ejector system. The forward and/or at least one aft tank transfer fuel to the main tank using gravity.

Preferably, the auxiliary fuel tank system of the present invention is installed into any modified aircraft such as a CRJ200, CRJ700 or the like. For example, the present invention may be implemented in aircrafts that are converted into VIP and Corporate Shuttle aircrafts.

Preferably, the auxiliary fuel tank system of the present invention is designed for ease of installation and maintainability and maximizes cabin space utilization. More specifically, there may be three auxiliary fuel tanks, two of them are staggered at the rear of the aircraft and one is located below a removable floor at the front. A preferred embodiment of the present invention offers an improved fuel capacity of approximately 675 us gal 4,500 lbs min.—ISA.

Advantageously, the auxiliary fuel tank system of the present invention includes virtually no electrical components. The system architecture is simple and therefore few parts are needed. The auxiliary fuel tank system is gravity fed and therefore does not require the installation of an auxiliary pump(s) or transfer valves. Indeed, the auxiliary fuel tank system of the present invention uses the pressure of an external refueling system to refuel the auxiliary fuel tank systems. Fuel is transferred from the auxiliary fuel system to the aircraft primary fuel system during flight by gravity.

Advantageously, the auxiliary fuel tank system offers increased passenger cabin space and versatility. Preferably, the aircraft is modified to remove weight so that the addition of the auxiliary fuel tank system does not increase the empty weight of the aircraft. Furthermore, with the combination of a forward tank to counterbalance the aft tank(s), the auxiliary fuel tank system of the present invention offers an improved weight distribution.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 is a rear perspective view of an aircraft skeleton comprising an auxiliary fuel tank system according to a preferred embodiment of the present invention;

FIG. 2 is a top elevated view of the interior of an aircraft according to a preferred embodiment of the present invention;

FIG. 3 is a front perspective view of a removable floor module according to a preferred embodiment of the present invention;

FIG. 4 presents multiple side views of the removable floor module for the forward tank attachments according to a preferred embodiment of the present invention;

FIG. 5 is a diagram representing the auxiliary fuel tank system components according to a preferred embodiment of the present invention;

FIG. 6A is a schematic diagram of the fuel circuit of the auxiliary fuel tank system of FIG. 5;

FIG. 6B and FIG. 6C are schematic diagrams of the fuel circuit of FIG. 6A during the aft fuel transfer;

FIG. 6D and FIG. 6E are schematic diagrams of the fuel circuit of FIG. 6A during the forward fuel transfer; and

FIG. 6F is a schematic diagram of the fuel circuit of FIG. 6A once fuel transfer has been completed.

### DESCRIPTION OF ILLUSTRATIVE EMBODIMENTS

The present invention is illustrated in further details by the following non-limiting examples.

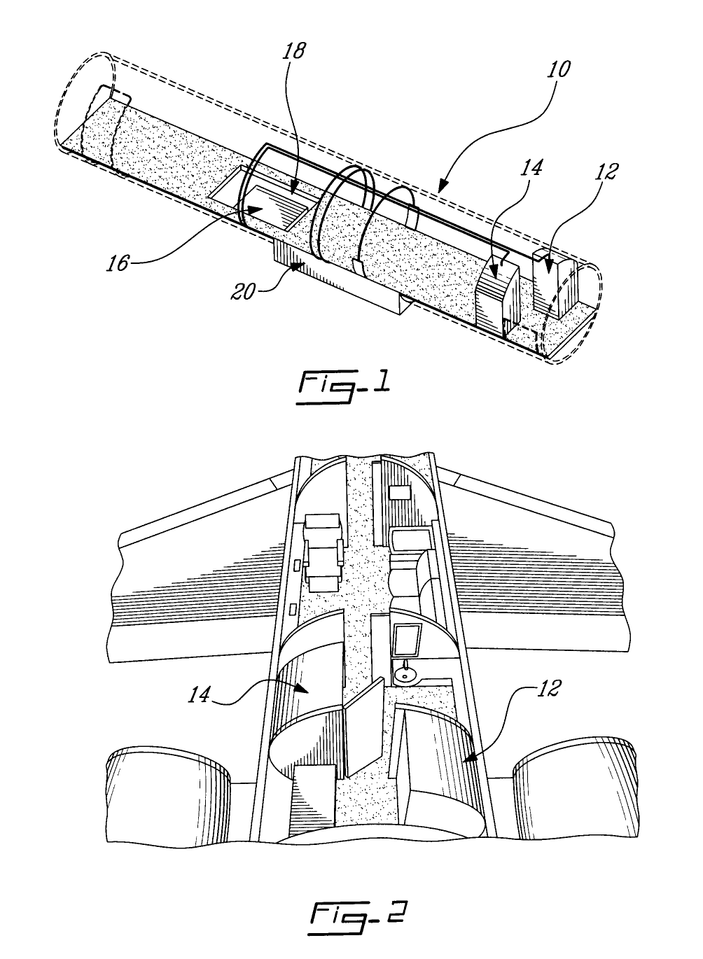

Referring to FIG. 1, the auxiliary fuel tank system, generally referred to using reference numeral 10, will be further described. The auxiliary fuel tanks are referred to using numerals 12, 14 and 16. Auxiliary fuel tank 16 is illustratively installed at the front and below a removable floor module 18. The main or center wing tank 20 is the aircraft's existing fuel tank.

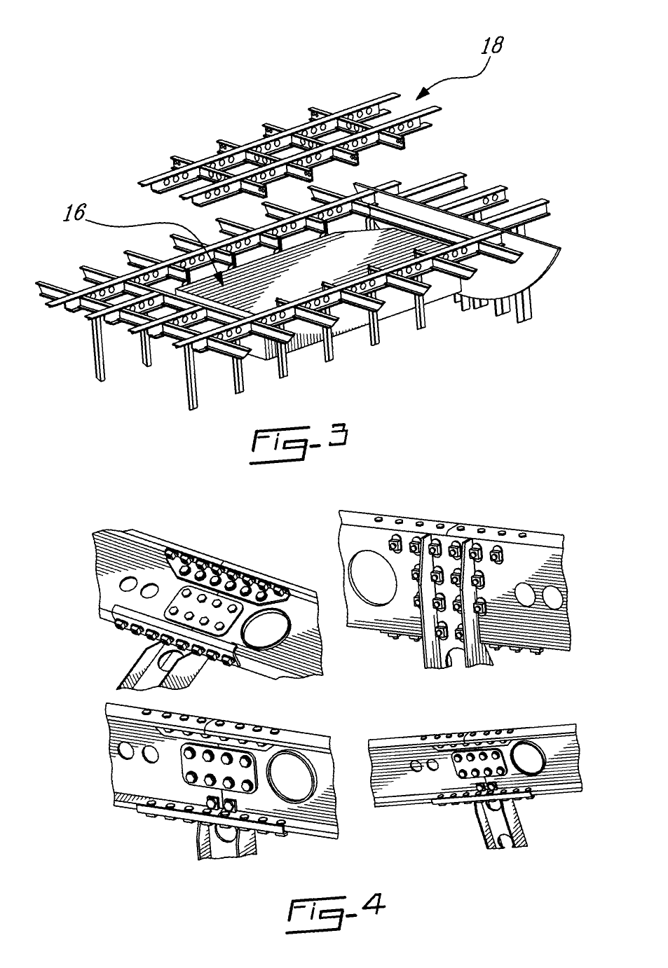

Referring now to FIG. 2, the positioning of the rear auxiliary fuel tanks 12 and 14 inside the aircraft can be seen. These fuel tanks are illustratively installed above the aircraft floor level and occupy a space defined between the ceiling, the floor and the sidewall of the aircraft, leaving space for a middle lane. Fuel tanks 12 and 14 are installed in a staggered configuration which results in larger usable cabin space, easier access to the baggage compartment, and better weight distribution on the floor structure. According to alternative illustrative embodiments of the present invention, the auxiliary fuel tanks 12, 14 and 16 may be installed independently of one another and the auxiliary fuel tank system 10 may therefore either comprise only the front auxiliary fuel tank 16, no front auxiliary fuel tank 16 and only a single aft auxiliary fuel tank 12 or 14, no front auxiliary fuel tank 16 and only both aft auxiliary fuel tanks 12 and 14, or all three auxiliary fuel tanks 12, 14, 16 may be present at the same time.

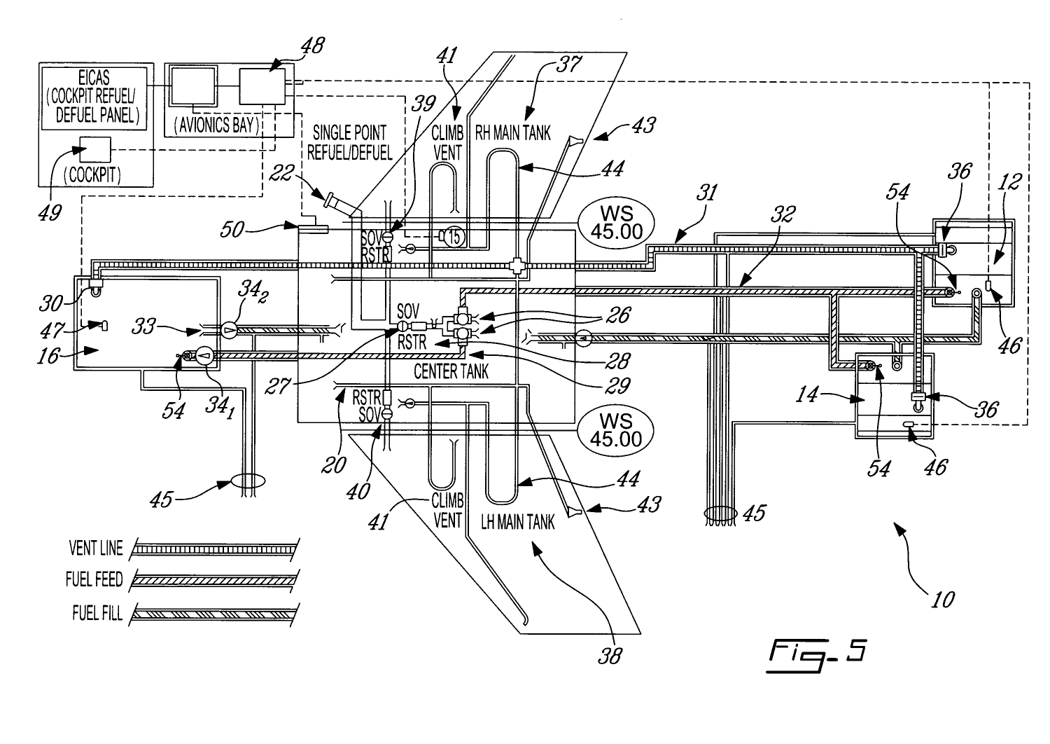

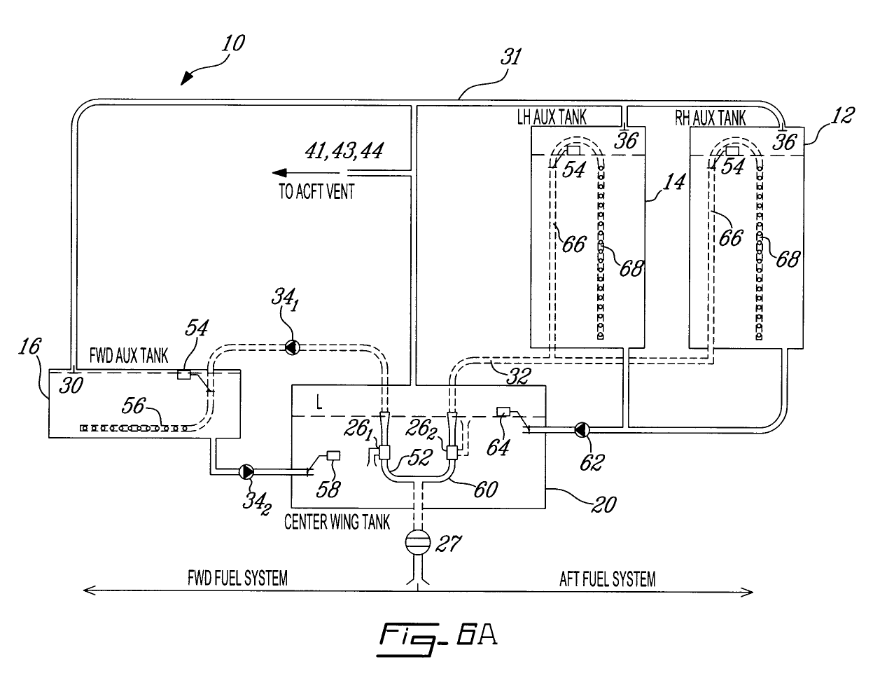

Referring to FIGS. 3 and 4, the positioning of the front auxiliary fuel tank 16 below a removable floor module 18 is shown. A preferred embodiment of the attachments between the beams constituting the removable floor module 18 is shown in FIG. 4.

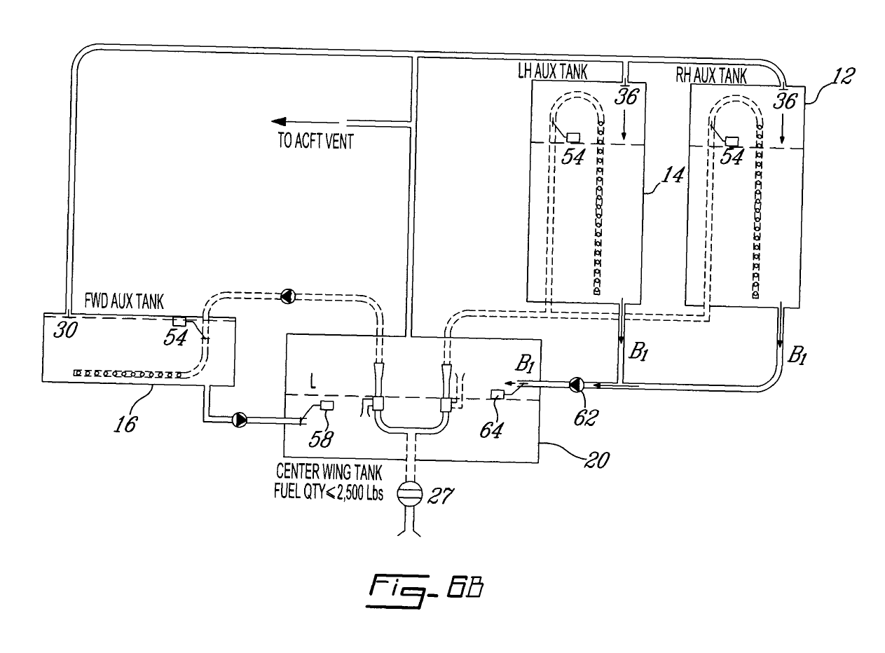

Referring now to FIG. 5, the auxiliary fuel tank system 10 components will be further described. In practice and as will be described in further detail herein below, fuel is transferred into the existing single point refuel assembly or wing root valve 22 via a refueling vehicle or station (not shown). The filling is made through the center tank 20 via two ejectors as in 26 that are connected to the existing fuel/defuel shut off valve 27 and restrictor 28. The forward auxiliary tank 16 is filled first via fueling/defuel transfer line 29 until a float valve 54 is closed by the rising fuel level thereby stalling the corresponding ejector 26. One-way fuel check valves 34 restrict fuel migration. As will be discussed further herein below, a vent valve 30, which is used as a back-up in case of failure of the float valve 54 and is similarly closed by the rising fuel to stall the ejector 26, is further coupled to a vent line 31 that connects to the existing aircraft fuel vent system 41, 43, and 44. A similar arrangement connects the rear tanks 12 and 14 through a vent valve 36 to the existing aircraft fuel vent system 41, 43 and 44. Once the forward tank 16 is filled, then the rear auxiliary tanks 12 and 14 are filled simultaneously via fuelling/defuel transfer lines 32 until the float valves 54 are closed by the rising fuel level thereby stalling the corresponding ejector 26. Thereafter, the existing aircraft fuel system fills per the original aircraft design as the auxiliary system 10 of the present invention advantageously does not affect the normal operation of the aircraft system and in particular does not affect the manner in which fuel is transferred from the center tank 20 to the remaining tanks, e.g. the wing tanks 37, 38. Finally, the existing wing tanks 37, 38 are filled via the existing fuel/defuel shut-off valves 39 and 40. The wing tanks 37, 38 use the existing climb vent lines 41, and NACA scoops 43, but include a vent modification described further below. In flight, fuel transfer is gravity fed starting with the auxiliary fuel tanks 12, 14, and 16 to ensure a controlled center of gravity of the aircraft. Fuel transfer lines 32 and 33 are sized to ensure a fuel transfer greater than the aircraft engine fuel burn rate at cruise. These lines 32, 33 are illustratively made using proven tubing and couplings with double wall and redundant electrical bonding compliant to the latest FAA, EASA requirements including SFAR88 (FAR25.981).

Still referring to FIG. 5, the venting system will further be described. The tank's vent line 31 is illustratively directly connected to the existing aircraft overboard fuel venting system and not directly into the center tank 20. Each tank 12, 14 and 16 is fitted with a shut-off vent valve 30 or 36 which can also be a float-type vent valve or any other type of equivalent mechanism that uses no electrical system and very few moving parts. In case of failure of the float valves 54, the vent valves 30 or 36 are illustratively closed by the rising fuel level in order to stall the ejectors 26 and prevent overfilling. The existing vent riser 44 is illustratively modified to be the highest point within the auxiliary fuel tank system 10 to ensure there is always air in the system and overboard siphoning does not occur.

The system 10 is illustratively constructed with a double walled concept for the portion of system located in the pressure vessel. The inner walls of the system 10 are the primary fuel or vent barrier. The outer wall is there to ensure fuel or fuel vapors do not enter the cabin area in the event of an inner wall failure. The area between the walls is drained to the atmosphere via drain 45.

Still referring to FIG. 5, the fuel indication control devices will be described. These control devices include fuel level sensing probes 46 in each of the aft tanks 12, 14 and a fuel sensing probe 47 in the forward tank 16. The sensing probes 46, 47 are connected to a fuel indicator manager 48 that is in turn connected to a fuel indicator 49 in the cockpit. The existing wing and center tank fuel quantities are fed to the fuel indicator manager 48. The fuel indicator manager 48 combines the totals and transfers the information to the refuel/defuel panel 50 to allow the fuel handler to select the desired amount of fuel to be loaded on the aircraft.

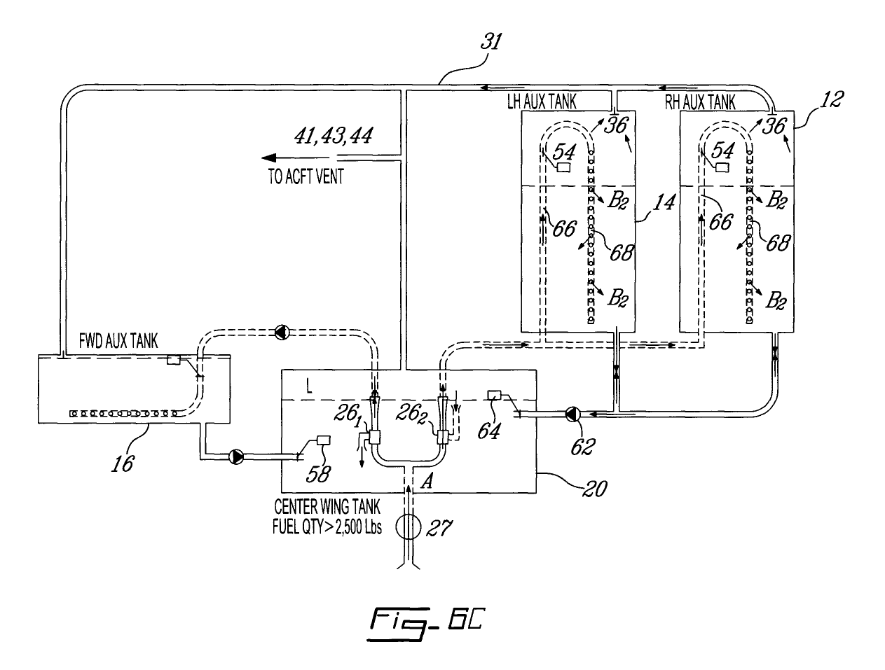

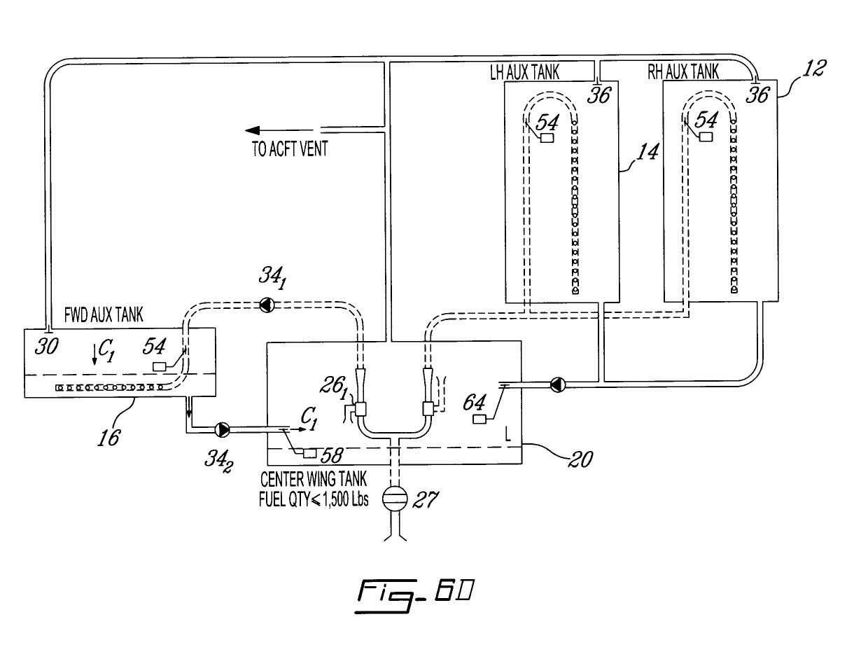

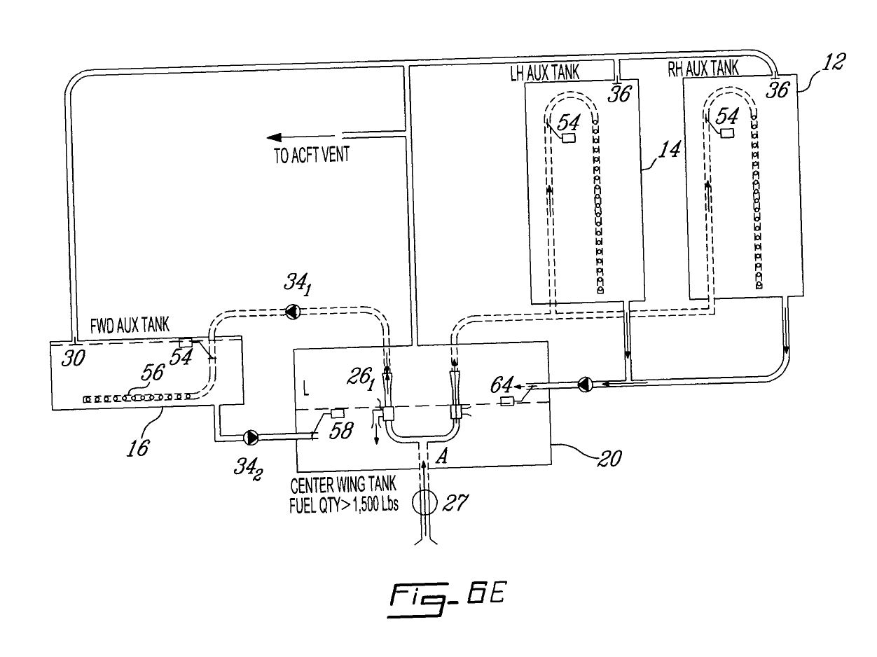

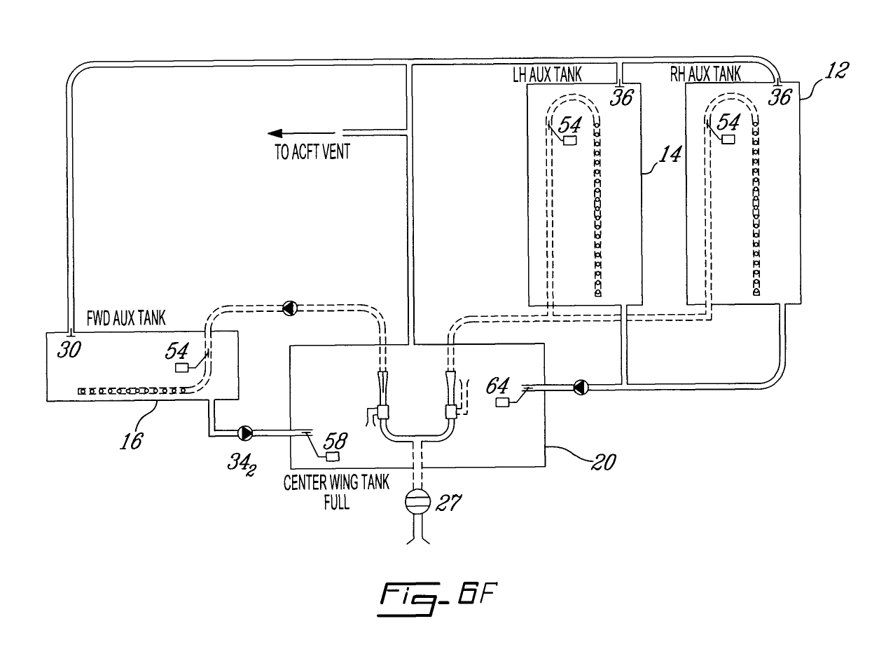

Referring now to FIG. 6A in addition to FIG. 5, the fuel transfer sequence of the auxiliary fuel tank system 10 will now be described. The auxiliary fuel tank system 10 illustratively comprises two separate circuits, namely a forward fuel circuit and an aft fuel circuit, which are based on the same principle and have essentially the same function and operation. The forward fuel circuit illustratively comprises a refuel motive flow line 52 connected to the forward refuel ejector pump 26₁, a fuel inlet line with the one-way check valve 34₁, a refuel shut off float valve 54, an in-tank fuel distribution line 56, a fuel outlet line with the one-way check valve 34₂, and a forward transfer/sequence float valve 58. Similarly, the aft fuel circuit illustratively comprises a refuel motive flow line 60 connected to the aft refuel ejector pump 26₂, the fuel transfer inlet line 32, a fuel transfer outlet line (not shown) with a one-way check valve 62, and an aft transfer/sequence float valve 64. In addition to the vent valve 36 and the aft auxiliary vent line 31 connected to the auxiliary vent system 41, 43, 44, each aft auxiliary fuel tank 12, 14, further comprises a fuel stack pipe 66, a refuel shut off float valve 54, and an in-tank fuel distribution line 68.

Still referring to FIG. 6A in addition to FIG. 5, either on the ground or in flight, the sequence of gravity fuel transfer from the auxiliary fuel tanks 12, 14, 16 to the center wing tank is illustratively set in three (3) stages. First, the aft auxiliary fuel tanks 12, 14 transfer fuel into the center wing tank 20 until the tanks 12, 14 become empty. Next, the forward auxiliary tank 16 transfers fuel into the center wing tank 20 until the forward auxiliary tank 16 becomes empty. Finally, the center wing tank 20 transfers all remaining fuel into the wing tanks 37, 38 until the center wing tank 20 becomes empty.

Referring now to FIG. 6B and FIG. 6C, as long as the quantity L of fuel in the center wing tank 20 is illustratively greater than about two-thirds of the tank's full capacity (e.g. 2,500 lbs for an aircraft of the CRJ 200 type), there will be no fuel transfer from the aft auxiliary fuel tanks 12, 14, nor from the forward auxiliary tank 16, into the center wing tank 20. However, if the quantity L of fuel in the center wing tank 20 is about two-thirds of the full capacity of the center wing tank 20 or slightly less (FIG. 6B), the aft transfer/sequence float valve 64 of the center wing tank 20 opens to initiate the refuel process of the center wing tank 20. During this refuel process, the fuel/defuel shut off valve 27 opens to enable fuel to be forced (along the direction of arrow A) through the forward and aft refuel ejector pumps 26₁ and 26₂, which respectively pump fuel into the forward and aft auxiliary fuel tanks 12, 14, 16, as will be described further herein below.

In particular, and still referring to FIG. 6B and FIG. 6C, as fuel is pumped into the aft auxiliary fuel tanks 12, 14 (from the fuel/defuel shut off valve 27 and through the aft refuel ejector pump 26₂), the fuel transfers to the center wing tank 20 at approximately the same rate and gradually raises the fuel level L in the center wing tank 20 so that fuel transfers by gravity from the aft auxiliary fuel tanks 12, 14 into the center wing tank 20 (along the direction of arrows B₁). When the quantity L of fuel in the center wing tank 20 reaches about two-thirds of the full capacity of the center wing tank 20 or more (FIG. 6C), the aft transfer/sequence float valve 64 closes. The fuel pumped into the aft auxiliary fuel tanks 12, 14 remains there and the aft auxiliary fuel tanks 12, 14 begin to fill (arrows B₂). Once the aft auxiliary fuel tanks 12, 14 are full, the aft refuel shut off float valves 54 (or alternatively the aft auxiliary fuel tank vent valves 36 in case of failure of the aft refuel shut off float valves 54) close. When this occurs, the aft refuel ejector pump 26₂ will be dead-headed and fuel is discharged into the center wing tank 20. The fuel level then gradually rises as more fuel is discharged into the center wing tank 20.

Referring now to FIG. 6D and FIG. 6E, if the quantity L of fuel in the center wing tank 20 is about a third of the tank's full capacity (e.g. 1,500 lbs for an aircraft of the CRJ 200 type) or slightly less (FIG. 6D), the forward transfer/sequence float valve 58 of the center wing tank 20 opens. Again, as fuel is pumped into the forward auxiliary fuel tank 16 (from the fuel/defuel shut off valve 27 and through the forward refuel ejector pump 26₁), the fuel drains at approximately the same rate and gradually raises the fuel level in the center wing tank 20 so that fuel transfers by gravity from the forward auxiliary fuel tank 16 into the center wing tank 20 (along the direction of arrows C₁). When the quantity L of fuel in the center wing tank 20 reaches about a third of the full capacity of the center wing tank 20 or more (FIG. 6E), the forward transfer/sequence float valve 58 closes. The fuel pumped into the forward auxiliary fuel tank 16 remains there and the forward auxiliary fuel tank 16 fully fills, at which point the forward refuel shut off float valve 54 (or alternatively the forward auxiliary fuel tank vent valve 30 in case of failure of the forward refuel shut off float valve 54) closes. When this occurs, the forward refuel ejector pump 26₁ will be dead-headed and fuel is then discharged into the center wing tank 20. The fuel level then gradually rises as more fuel is discharged into the center wing tank 20.

Referring now to FIG. 6F, when the center wing tank 20 is full, the transfer of fuel from the forward and the aft auxiliary fuel tanks 12, 14, 16 to the center wing tank 20 has been completed and the fuel/defuel shut off valve 27 closes. The remaining fuel in the center wing tank is then gradually transferred into the left and right wing tanks (references 37, 38 in FIG. 5), as mentioned herein above.

As will be apparent from the description herein above, the forward transfer/sequence float valve 58 and the aft transfer/sequence float valve 64 advantageously sequence the refuel of the forward and aft auxiliary fuel tanks 12, 14, 16, sequence the transfer of fuel from the forward and aft auxiliary fuel tanks 12, 14, 16 to the center wing tank 20, and protect the forward and aft auxiliary fuel tanks 12, 14, 16 from over-pressure during the refuel process. Moreover, due to the simplicity of the gravity-fed system architecture, the auxiliary fuel tank system of the present invention includes virtually no electrical components while illustratively offering an improved fuel capacity, increased passenger cabin space and versatility.

Although the present invention has been described hereinabove by way of specific embodiments thereof, it can be modified, without departing from the spirit and nature of the subject invention as defined in the appended claims.

1. An auxiliary fuel tank system connected to a main tank of an aircraft having a refuel input assembly, the auxiliary fuel tank system comprising:
an ejector system operatively connected to the refuel input assembly; and
a forward tank operatively connected to the ejector system, and/or at least one aft tank operatively connected to the ejector system;
wherein said forward and/or at least one aft tank transfer fuel to the main tank using gravity.

2. The auxiliary fuel tank system of claim 1, wherein said ejector system comprises a first and/or a second ejector pump, said forward tank operatively connected to said first ejector pump via a first flow line and said at least one aft tank operatively connected to said second ejector pump via at least one second flow line.

3. The auxiliary fuel tank system of claim 2, wherein if the quantity of fuel in the main tank is greater than about two-thirds of a full capacity of the main tank no fuel is transferred from said forward tank and/or at least one aft tank to the main tank.

4. The auxiliary fuel tank system of claim 2, further comprising a shut off valve connected to said first and/or said second ejector pumps, wherein when said shut off valve opens, fuel is forced from said first ejector pump through said first flow line for filling said forward tank and/or from said second ejector pump through said at least one second flow line for filling said at least one aft tank.

5. The auxiliary fuel tank system of claim 4, further comprising a first fuel transfer line for connecting the main tank to said forward tank, a forward transfer valve ending said first fuel transfer line, and at least one second fuel transfer line for connecting the main tank to said at least one aft tank, an aft transfer valve ending said at least one second fuel transfer line.

6. The auxiliary fuel tank system of claim 5, wherein if the quantity of fuel in the main tank is lower than said two-thirds of said full capacity of the main tank said shut off valve and said aft transfer valve open for forcing fuel through said second ejector pump and into said at least one aft tank.

7. The auxiliary fuel tank system of claim 6, wherein when said at least one aft tank is full, said aft transfer valve closes for stalling said second ejector pump to prevent overfilling of said at least one aft tank and fuel is transferred by gravity from said at least one aft tank into the main tank, thereby filling the main tank.

8. The auxiliary fuel tank system of claim 7, wherein if the quantity of fuel in the main tank is lower than about one-third of said full capacity of the main tank said shut off valve and said forward transfer valve open for forcing fuel through said first ejector pump and into said forward tank.

9. The auxiliary fuel tank system of claim 8, wherein when said forward tank is full, said forward transfer valve closes for stalling said first ejector pump to prevent overfilling of said forward tank and fuel is transferred by gravity from said forward tank into the main tank, thereby filling the main tank.

10. The auxiliary fuel tank system of claim 9, further comprising a first vent line connecting said forward tank to a venting system of the aircraft, a first vent valve comprised in said forward tank and ending said first vent line, wherein in case of failure of said forward transfer valve during the filling of said forward tank a rising fuel level displaces air through said first vent valve, thereby closing said first vent valve and stalling said first ejector pump to prevent overfilling of said forward tank.

11. The auxiliary fuel tank system of claim 10, further comprising at least one second vent line connecting said at least one aft tank to said venting system, at least one second vent valve comprised in each of said at least one aft tank and ending said at least one second vent line, wherein in case of failure of said aft transfer valve during the filling of said at least one aft tank a rising fuel level displaces air through said at least one second vent valve, thereby closing said at least one second vent valve and stalling said second ejector pump to prevent overfilling of said at least one aft tank.

12. The auxiliary fuel tank system of claim 1, wherein two of said aft tank are located at the rear of the aircraft in a staggered relationship.

13. The auxiliary fuel tank system of claim 1, wherein said forward tank counterbalances a weight of said at least one aft tank.

14. The auxiliary fuel tank system of claim 1, further comprising a removable floor module and wherein said forward tank is located below said removable floor module.

15. The auxiliary fuel tank system of claim 1, wherein said auxiliary fuel tank system is constructed using a double walled configuration.

16. The auxiliary fuel tank system of claim 1, further comprising at least one fuel sensing probe in each one of said forward tank and said at least one aft tank for measuring a current fuel level therein.

17. The auxiliary fuel tank system of claim 15, further comprising a fuel indicator manager connected to said at least one fuel sensing probe, said at least one fuel sensing probe transmitting to said fuel indicator manager said measured fuel level for controlling an amount of fuel to be loaded on the aircraft.
